(19) United States
(12) Patent Application Publication
(10) Pub. No.: US 2006/0002102 A1
(43) Pub. Date: Jan. 5, 2006

(54) Volatile material dispensing system with illuminating device

(76) Inventor: Stephen B. Leonard, Franksville, WI (US)

Correspondence Address: S.C. JOHNSON & SON, INC., 1525 HOWE STREET, RACINE, WI, 53403-2236, US

(21) Appl. No.: 10/880,885

(22) Filed: Jun. 30, 2004

(51) Int. Cl. F21V 33/00

(52) U.S. Cl. 362/96; 362/253

(57) ABSTRACT

A volatile material dispensing system with a dispenser for providing controlled release of a volatile material, the dispenser being attached to a display frame, the display frame is secured to a base member that additionally retains an illuminating means. The illuminating means provides a pleasing ambiance in conjunction with the pleasant air freshener released by the dispenser.

### REFERENCES TO OTHER PENDING APPLICATIONS

This is related to the following co-pending applications filed concurrently herewith: Volatile Material Expiration Indicating System, Ser. No. ______ Attorney Docket Number J-4023 and Volatile Material Dispensing System, Ser. No. ______ Attorney Docket Number J-4030.

### FIELD OF THE INVENTION

The invention generally relates to volatile material dispensers. More specifically, the invention relates to a volatile material dispenser that utilizes a decorative display frame in conjunction with an illuminating device.

### BACKGROUND

A variety of methods have been utilized to contain volatile materials and permit the controlled dispensing of these materials as vapors into the ambient air. The prior art describes in detail the use of permeable membranes, as well as other manners to dispense volatile material from a given dispenser. A variety of volatile material dispensers have been designed to be positioned in various open and closed areas, dependent upon the particular need for the dispenser. Furthermore, the prior art describes manners and devices for displaying the dispensers.

Specific to personal living spaces and professional office settings, there is a desire to make the ambient air more pleasing. Additionally, there is a desire for insect and pest control in these spaces and is an ongoing need. The prior art describes many such devices that may be employed for use in these spaces for both air freshening and insect control.

Due to the nature of the problem that is being combated, air treatment/freshening and insect control, there is a societal stigma associated with the presence of such noticeable devices within the personal living spaces and professional office settings where the devices may be employed. An unsightly and clearly identified device is not desirable in such settings. Furthermore, it is preferable to have such a device that can be displayed in sensitive settings, as described above, that would not only prevent a negative social stigma, but would act in a decorative manner and provide aesthetic appeal to the user. It is desired to have a decorative container for dispensing fragrances and other volatile materials while adding the ambiance enhancing features of light, most desirable through candle light. Furthermore, it is desirable to utilize the heat generated from such a light source to assist in disseminating the fragrance throughout a living or working space.

U.S. Pat. No. 4,714,984 discloses a night light assembly. The night light assembly, when switched on, produces a low-level illumination and at the same time exudes an aromatic vapor. The assembly includes a reflector shell having housed therein a low-wattage bulb.

U.S. Pat. No. 6,663,838 discloses a heated volatile dispenser. The dispenser has a closed heating chamber having ceiling and exit vents. Included is a candle and a volatile carrier that are designed to be exhausted at the same time so that the candle's consumption serves as a use-cue for the volatile carrier.

U.S. Pat. No. 4,695,435 discloses a light-activated aroma generator. The aroma generator is rendered operative only when one turns on an electric light bulb in the room in which the generator is installed.

U.S. Pat. No. 6,144,801 discloses a perfume diffuser. The perfume diffuser uses a perfume burner as a source of heat and is a small candle which is placed under the container, which generally contains a liquid adapted to evaporate a perfume, and which heats the container to heat said substance so that it evaporates.

The problem with the prior art is that it does not describe a decorative volatile material dispenser that may be displayed and prominently positioned so that the dispenser may be pleasing to the eye and add ambiance to a plurality of settings. Furthermore, there is not such a dispenser that may be enhanced through the use of an illuminating means, whether it be electrically configured, a candle, or some other illuminating means. Furthermore, there is not such a device that provides a reflective device to enhance convective flow and concentration of emanating light upon the dispenser.

The invention solves a problem that is necessary to provide ambiance and enhance fragrance release into the atmosphere than would otherwise occur with out light or heat.

The present invention solves this problem by providing for a decorative volatile material dispenser that provides a pleasing ambiance and improves the ambient atmosphere.

### SUMMARY OF THE INVENTION

In accordance with a first aspect of the invention, a volatile material dispensing system includes a volatile material dispenser configured to dispense a volatile material into an ambient atmosphere and a volatile material contained within the dispenser. The volatile material is selected from a group consisting of air fresheners, perfumes and insecticides. Additionally, a base member is provided that includes a dispenser detaining means and an extension surface attached to the detaining means, wherein the base member is configured to releasably attach to the dispenser. Also provided is an illuminating device configured to illuminate the dispenser. Also the extension surface is configured to support the illuminating device.

In accordance with a second aspect of the invention, a volatile material dispensing system includes a volatile material dispensing means for dispensing a volatile material into an ambient atmosphere and a planar frame having a front face and a rear face, and the dispensing means is affixed to the frame. Also provided is an illuminating device configured to illuminate the frame and positioned upon an extension surface and a reflective device configured to reflect heat and light emanating from the illuminating device. Also the illuminating device is positioned substantially between the frame and the reflective device.

In accordance with a third aspect of the invention, an illuminated volatile material dispenser includes a dispensing apparatus configured to support a reservoir containing a volatile material enclosed by a vapor permeable membrane having a surface coplanar with a face of said dispensing apparatus and an illuminating device configured to illuminate the frame and positioned upon an extension surface. Also including a reflective device configured to reflect heat and light emanating from said illuminating device, wherein said illuminating device is positioned substantially between said frame and said reflective device, wherein said illuminating device is proximal to said face.

Other features will become apparent to those skilled in the art from a review of the following detailed description, taken in conjunction with the drawings and the appended claims. While the disclosed dispenser is susceptible of embodiments in various forms, described below are specific embodiments that are intended as illustrative (and not intended to limit the disclosure to the specific embodiments described herein).

### BRIEF DESCRIPTION OF THE DRAWINGS

FIG. 1 is an exploded back perspective view of the system.

FIG. 2 is a perspective view of the dispenser shown in FIG. 1.

FIG. 3 is a perspective view of the assembled system shown in FIG. 1.

FIG. 4 is an exploded front perspective view of the system.

FIG. 5 is a back face view of the system with a dispenser in the first filled condition.

FIG. 6 is a sectional view of the system taken substantially along line 6-6 of FIG. 5.

FIG. 7 is a partial enlarged sectional view of the dispenser shown in FIG. 6.

FIG. 8 is a front face view of the system with a partially evacuated dispenser.

FIG. 9 is a sectional view of the system taken substantially along line 9-9 of FIG. 8.

FIG. 10 is a partially enlarged sectional view of the system shown in FIG. 9.

FIG. 11 is a partially enlarged sectional view of the dispenser taken substantially along line 11-11 of FIG. 8.

FIG. 12 is a front face perspective view of the first embodiment of the system.

FIG. 13 is a sectional view of the system taken substantially along line 13-13 of FIG. 12.

FIG. 14 is a front face perspective view of the second embodiment of the system.

FIG. 15 is a sectional view of the system taken substantially along line 15-15 of FIG. 14.

### DETAILED DESCRIPTION

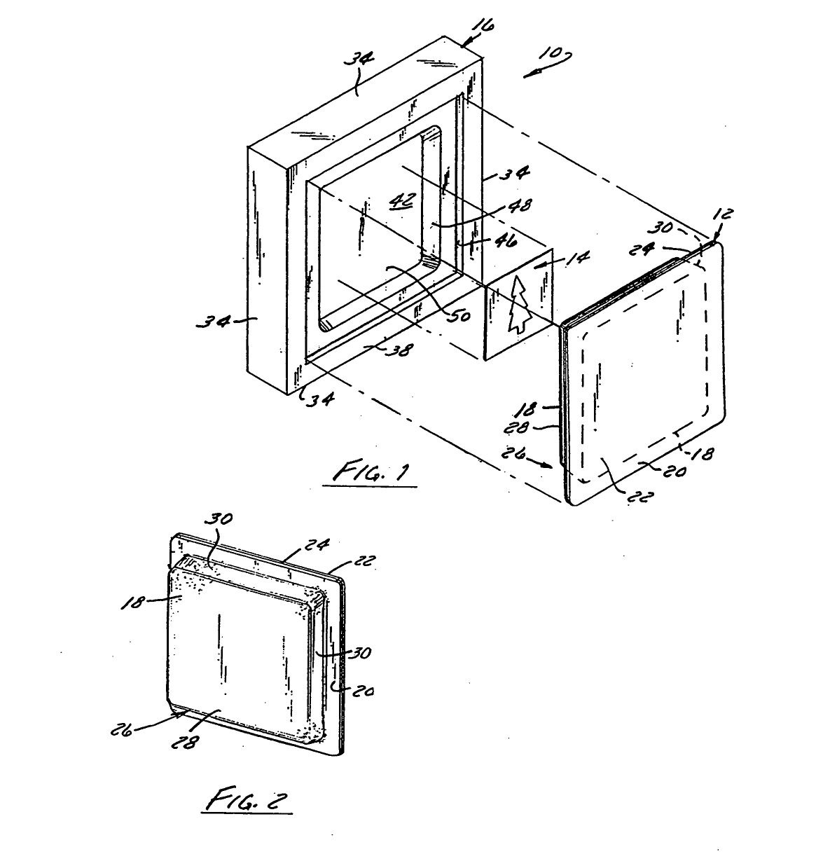

Referring to FIGS. 1 and 2, a volatile material dispensing system 10 is illustrated, the system 10 having an evacuatable material dispenser 12, a decorative image 14, and a display frame 16 for holding the dispenser 12. The decorative image 14 is attached to the frame 16. The image 14 may be printed, formed or etched onto the frame. Additionally, a silk screen image 14 may be used.

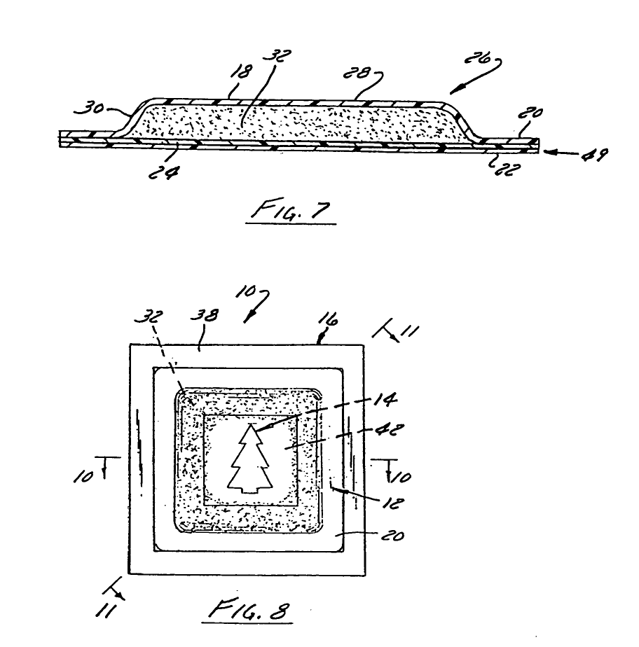

The dispenser 12 includes a blister 18, a peripheral flange 20, and an impermeable laminate 22 releasably adhered to said blister 18. The blister 18 includes a non-porous permeable membrane 24 comprised of low density polyethylene (LDPE), and a cup-shaped structure 26. Cup 26 includes a recycled polyethylene terephthalate (RPET) layer adhesively bonded to a nylon laminate. The nylon laminate includes a layer of ethylene vinyl acetate (EVA) coextruded to each side of a middle nylon layer. The cup 26 includes a bottom wall 28 and four side walls 30, that in conjunction with the membrane 24 acts as a sealed reservoir to contain the volatile material 32 (FIG. 7).

The laminate 22 includes a layer of polypropylene, aluminum foil, and polyester. The polypropylene is adhesively bonded to the aluminum foil layer, which is adhesively bonded to the polyester layer. An extrusion bonding material is used to bond the layers together. Laminate 22 preferably has a thickness of between 0.1 to 0.2 mm. The polyester layer is suitable for printing and is the outer surface of laminate 22. Preferably the membrane 24 and polypropylene layer of laminate 22 are coextruded when the blister is manufactured. The coextrusion permits for the laminate 22 to be peelably removed from the blister 18 while avoiding unnecessary reactions between an adhesive and the volatile material 32 during diffusion.

Cup 26 preferably has a thickness between 0.3 to 0.4 mm. The cup 26 is generally rectangular and preferably square with overall dimensions of about 3-5 mm thick, 50-60 mm long and 50-60 mm wide. Each of its four sidewalls 30 has a corresponding width of 3-5 mm and a length of 50-60 mm. Sidewalls 30 taper slightly outward as one moves from the bottom wall to the flange 20. Bottom wall 28 is also generally rectangular and has width of 48-58 mm and a height of 48-58 mm. The sidewalls 30 and bottom wall 28 of cup 26 are preferably thermoformed from a single sheet of the RPET and nylon laminate that is heated, then either blown or pressed into the flange-and-cup arrangement shown in the FIGURES. Preferably the cup 26 is clear and translucent, allowing for the visibility of the volatile material 32 contained within the blister 18.

The cup 26 contains relatively shallow side walls 30, as stated above. The shallow nature of the blister 18 allows for the membrane 24 to collapse upon the bottom wall 28. Diffusion of the volatile material 32 through the membrane 24 creates collapsing of membrane 24 upon wall 28 that maintains contact between the volatile material 32 and the membrane 24. The contact allows for a greater percentage of overall volatile material 32 diffusion and allows for indication of volatile material 32 expiration.

Peripheral flange 20 is preferably planar. It is coupled to and extends outward from the top edges of the cup 26 (e.g. the upper edges of sidewalls 30). Flange 20 is integrally formed with the cup 26 in a thermoforming process, as described in the preceding paragraph.

Following placement of the volatile material 32 into the cup 26, a seal is made between the flange 20 and the permeable membrane 24 thereby forming the dispenser 12. At the same time laminate 22 may be attached to the blister 18 by having already been adhered to the membrane 24. The membrane 24 and laminate 22 may be attached to the flange 20 of the blister 18 using any conventional means, such as an adhesive, heat sealing, crimping, or the like. The seal must be air-tight so as to prevent leakage of air or volatile material 32. Most preferably the membrane 24 and the laminate 22 are sealed to the cup 26 in a single step. The volatile material 32 does not completely fill the void within the blister 18. A relatively small amount of air can be tolerated in dispenser 12 following the creation of blister 18. Preferably the air in the sealed blister is no more than 3-6% of the overall volume of the blister 18. As the volatile material diffuses out of dispenser 12 no air enters the blister 18 through the permeable membrane 24. The membrane 24 is configured to distend and collapse without the formation of gas bubbles.

Preferably, the removal process will occur by a user grasping an end of the laminate 22 and peeling it off the blister 18. A tab, extension, or other means for grasping (not shown) may be included as an extension of the laminate 22 to aid in removal of the laminate 22. The extension may be at the corners, ends, or on the surface of the laminate 22.

Permeable membrane 24 has a thickness of about 0.05 to 0.15 mm and has a density preferably between 0.88 and 0.95 grams/cubic centimeter. It is formed integrally with laminate 22 and is heat fused to flange 20 such that membrane 24 extends across the entire cup 26. Membrane 24 encloses and seals the cup 26 with the volatile material 32 stored inside thereby forming a thin sealed container impermeable to the volatile material 32 stored inside. This container remains impermeable until the user grasps a corner of laminate 22 and peels laminate 22 from the membrane 24, thereby exposing permeable membrane 24 and permitting the volatile material 32 to migrate through the permeable membrane 24 and diffuse into the ambient air. The membrane 24 is preferably comprised of LDPE and is clear and translucent, allowing for visibility of the volatile material contained within the blister 18.

Frame 16 is a rectangular structure, preferably square, with four substantially equal-sized side walls 34, a front face 36 (FIG. 4) and a rear face 38. Frame 16 preferably has a thickness of between 12 and 22 mm and a height and width of between 70 and 90 mm. More preferably frame 16 has a width of approximately 15 mm and height of approximately 80 mm. Preferably the front face 36 of frame 16 will have a surface area greater than 3000 mm².

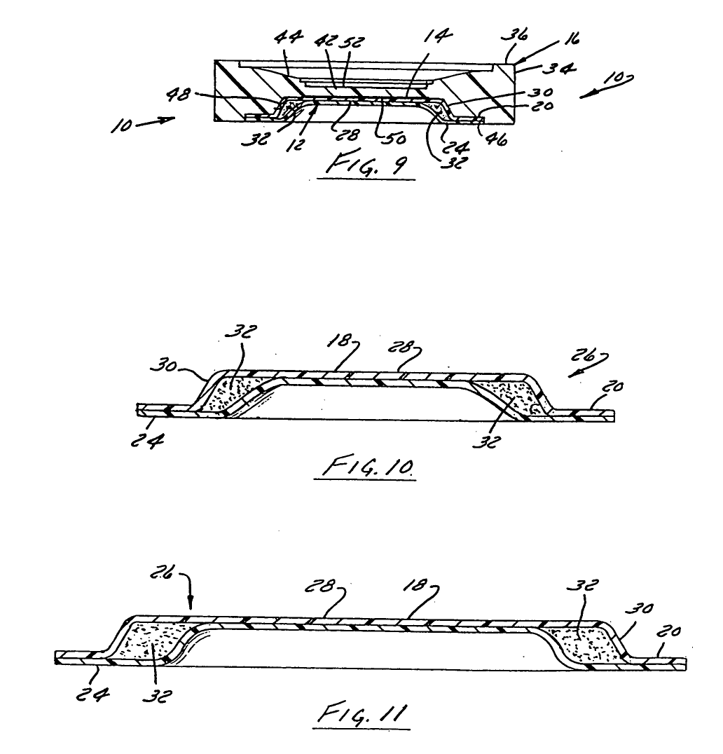

Front face 36 has a stepped recess 40 (FIG. 4). Recess 40 gives frame 16 the appearance of a picture frame surrounding and framing the bottom (or back) wall 42 (FIG. 4) of the recess 40. In the preferred embodiment, shown in FIGS. 6 and 9, the walls of recess 40 appear in cross section to have steps or curves 44 in the manner of an ornate picture frame. The recess 40 preferably centered in the front face 36 and is disposed away from the side walls 34. The recess 40 does not extend to the edge of the front face 36. Instead, front face 36 appears as a border extending around the edges of the recess 40, having a constant width between 2 and 4 mm.

Wall 42 is preferably transparent or translucent to permit light to pass through. Wall 42, in that regard, may function as a window that permits the viewer (from the front) to visually perceive what is directly behind wall 42.

Rear face 38 of frame 16 also is recessed. This recess is similarly stepped, and is configured to completely receive dispenser 12, with dispenser 12 positioned so that the membrane 24 surface is substantially flush with rear face 38. The recess is also preferably stepped, having a shallower peripheral recess 46 extending all the way around rear face 38 and a deeper central recess 48. The deeper central recess 48 is configured and dimensioned to receive cup 26, and the peripheral recess 46 is configured and dimensioned to receive and support flange 20. In short, the central recess 48 and peripheral recess 46 combined have a negative shape that is the same as that of dispenser 12.

Peripheral recess 46 preferably has an adhesive, spring clip, or other mechanical or adhesive retaining means that is configured to hold flange 20 in place. Flange 20 and peripheral recess 46 may be adhered to one another through the use of any adhesive, or alternatively though a mechanical means, such as interference fit, or separate mechanical fastener, such as a spring clip. When an adhesive 49 is used (as shown herein), a flange-to-frame adhesive may be chosen to either permanently adhere the flange 12 to the display frame 16 or, alternatively, be releasably adhered N for easy removal. In this manner, frame 16 can be a permanent and reusable item to which a succession of replacement dispensers 12 are affixed and later removed and replaced. Preferably an ultra violet (UV) cured adhesive is used. In this manner, frame 16 can be a permanent and reusable item to which a succession of replacement dispensers 12 are affixed and later removed and replaced.

Central recess 48 is deeper than peripheral recess 46 since it must accommodate the greater combined thickness of cup 26, flange 20 and membrane 24. The bottom of cup 26 is adjacent to and preferably slightly spaced apart from the bottom 50 of central recess 46. Central recess 48 and peripheral recess 46 are preferably centrally spaced from the internal edges of rear face 38.

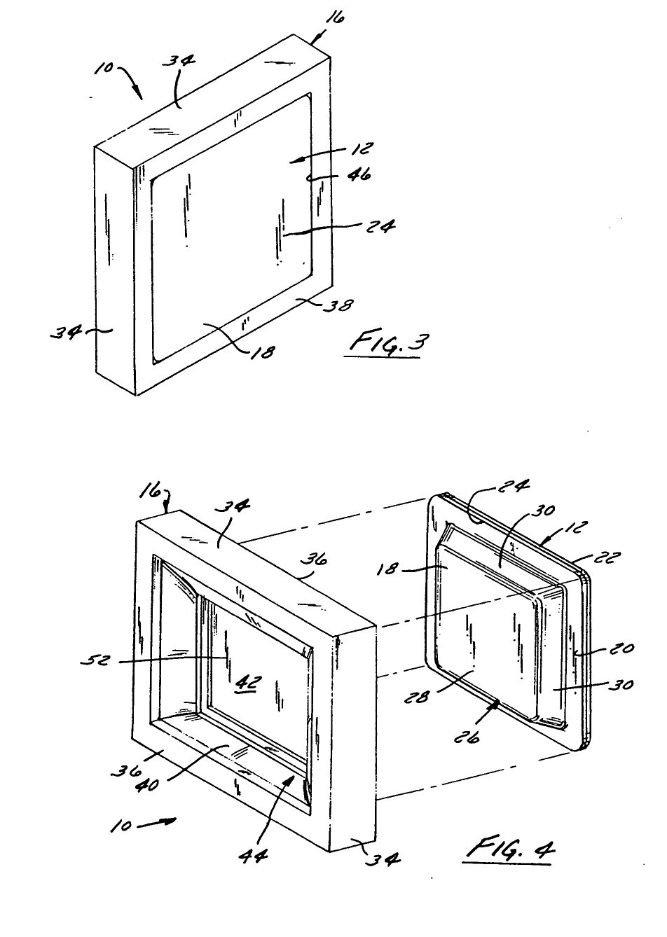

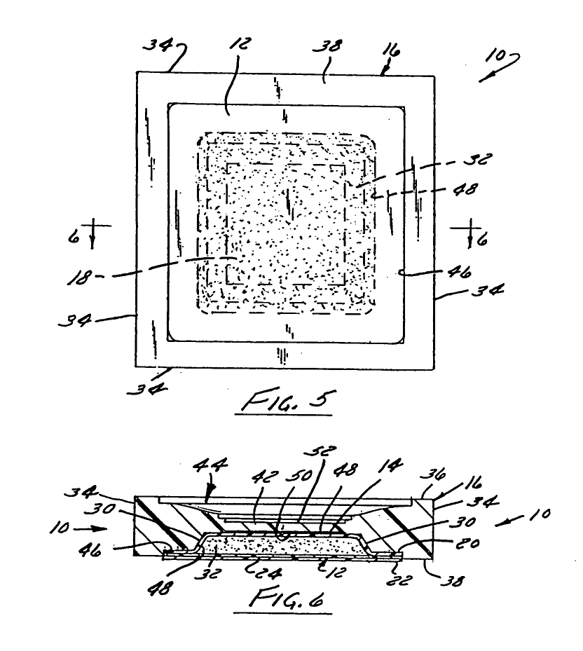

The distance between the bottom 50 (FIG. 1) of central recess 48 and the bottom 52 (FIG. 4) of recess 40 on the front face 36 of frame 16 (i.e. the thickness of wall 44), is preferably between 2 and 5 mm. Wall 42 may be transparent or translucent. The translucent properties of wall 42 enables the user to easily identify when the volatile material 32 has nearly all diffused through membrane 24. Additionally, the translucent properties of wall 42 have a decorative function. The frame is best shown (FIGS. 3 and 4) to represent the translucent properties of wall 42.

The display frame 16 may be constructed from a variety of compositions, including glass, injection-molded plastic, or copolyester resin. In the preferred embodiment, the display frame 16 is constructed from molded glass that is clear and transparent. Alternatively, frame 16 may be constructed from a variety of solid colors or color combinations in either the plastic or glass construction. Pigmented frames provide an aesthetic value to the system 10, particularly when light is concentrated through the frame 16 or reflected and refracted through the frame 16.

Blister 18 of the dispenser 12 is filled with a volatile material 32. It is particularly suited for use in holding a volatile material 32 comprising an active ingredient, which is to be slowly diffused into the surrounding atmosphere, such as a fragrance, air freshener, insect repellant insecticide. In addition to the active ingredient the preferred embodiment includes a dye and thickening agent that color and thicken the volatile material 32. The dye and thickening agent most preferably comprise less than 2% of the overall composition.

Insecticides and other related chemicals may also be utilized as the volatile material 32. Where the user does not wish to have an unsightly insect repellant device, but requires the utility of a repellant, the decorative system is advantageous and blends in with the surrounding decor. The indicator system 10 allows for such a volatile material 32 to be released while having a decorative appearance.

When volatile material 32 is a fragrance, the fragrance can be relatively simple in composition, or can be a complex mixture of natural and/or synthetic chemical compounds. Various mixtures of volatile materials for use in the indicator system may comprise as few as two chemicals and as many as over one hundred. Most conventional fragrance materials are synthetic or naturally derived volatile essential oils, such as, for example, lemon, mandarin, caraway, cedar leaf, clove leaf, cedar wood, oil of bergamot, bitter orange, geranium, lavender, orange, origanum, lavandin, neroli, rose absolute, cinnamon, and the like. Many of these materials may adversely affect treated surfaces on furniture. Synthetic types of fragrance composition, either alone or in combination with natural oils, are described in U.S. Pat. Nos. 4,314,915; 4,411,829; and 4,434,306, which are incorporated herein by reference. The image 14 (FIGS. 1 and 8) may be graphic or textual. It may read, for example, “Please Replace.” The image may be positioned in a plurality of positions, including but not limited to the following: front face 36 of frame, rear face 38 of frame, upon the permeable membrane 24, or upon the bottom wall 28 (FIG. 4). The image may be printed upon a layer of primed polyester that is adhesively adhered to the system 10, as described above. Alternatively, the image may be thermoformed into the bottom wall 28, molded into the decorative frame 16, or etched onto the frame 16.

The image 14 is shown in the shape of a tree, but may also be chosen from festive images used during various holiday seasons, such as a Christmas tree, menorah, Easter egg, valentine heart, pumpkin, and the like. Additionally, the color of the volatile material may be chosen in conjunction with such images to aid in celebration of the respective holidays. Multiple color combinations may be utilized in accordance to the decorative tastes of the user. The image 14 may be a plurality of other images that may include flowers, wildlife, cosmic displays, sporting related, and the like.

Depending upon the type and amount of dye utilized in conjunction with the volatile material 32 and the positioning of the image 14, either in front of or behind volatile material 32, the image 14 may or may not be viewable when the blister 18 is filled. Preferably the image is not viewable until a majority of the volatile material 32 has been released, and the dispenser 12 nears an empty or second condition, so as to more clearly indicate use-up of the volatile material 32. Most preferably, the image 14 is viewable when the dispenser 12 is full, empty, and at any point in between. However, the image 14 would be more readily viewable when the dispenser 12 is empty, in order to enhance the decorative nature in conjunction with dispenser 12 use-up. For purposes of the present invention, expiration of the volatile material 32 or system 10 refers to use-up of the volatile material 32.

When packaged the dispenser 12 is filled (FIG. 7) with volatile material 32 and laminate 22 is adhered to the permeable membrane 24. There is virtually no diffusion of volatile material 32 when the dispenser is filled and laminate 22 covers membrane 24. Following removal of laminate 22, the system 10 begins to transition towards an empty or second condition. Of course, there may be a small amount of volatile material 32 that remains and the dispenser 12 will be considered to have reached the second condition. As the volatile material 32 diffuses through the membrane 24, the membrane 24 slowly collapses upon the bottom wall 28. Following diffusion of the volatile material 32 across the membrane 24 there is less material 32 contained within dispenser 12. Virtually no new air enters the dispenser 12 subsequent to diffusion of volatile material 32. The result of this is a pressure gradient across the membrane 24, with a higher pressure existing in the ambient air than the pressure in dispenser 12. The pressure gradient causes the ambient air to exert a net positive pressure upon the dispenser, which presses the membrane 24 against the remaining volatile material 32 and ultimately the bottom wall 28. Continued diffusion of the volatile material 32 increases the force exerted upon the membrane 24, which causes the remaining volatile material to migrate from a center of wall 28 towards the periphery of wall 28. Continued migration and diffusion of the volatile material 32 results in an increasing surface area contact between membrane 24 and wall 28 until dispenser 12 is empty, or nearly empty. Increasing contact between the membrane 24 and the wall 28 allows for the image 14 to be more readily viewable. The pressure gradient ultimately resulting in migration of the volatile material 32 may also be viewed as occurring due to an increasing compressed vacuum presence within dispenser 12 as the volatile material continues to diffuse across membrane 24.

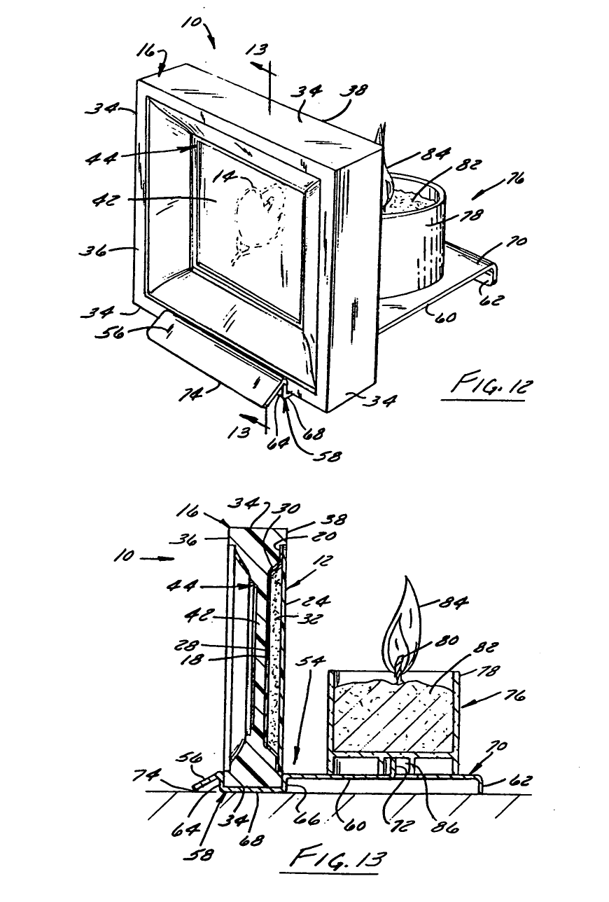

Referring to FIGS. 8-11, a small amount of volatile material 32 remains within the dispenser 12 when it is nearly empty, and is present in the form of a ring-like appearance towards the periphery of the bottom wall 28. A dye and thickener combine to comprise approximately 2% of the overall volatile material composition of the system 10 at the first condition. Preferably a higher concentration of dye is present in the volatile material 32 when the dispenser 12 is nearly empty, as the dye utilized does not easily diffuse across membrane 24. This results in a more readily viewable ring-like appearance. The color of the ring-like image is more intense in color than the coloration of the first condition because of the increased concentration of dye material. In the second condition the thickener and dye comprise nearly all of the material left within the dispenser 12. Of course, this may change dependant upon the particular dye composition and thickening agent utilized in the volatile material 32. As the system 10 approaches and is in a second condition, the nearly expired dispenser 12 can be seen so as to indicate its end of life.

When the dispenser 12 is full, or in the first condition, a decorative image may not be seen through the colored or opaque volatile material 32. As the dispenser 12 empties, or reaches the second condition, the decorative image 14 becomes viewable indicating a level of expiration or use-up. Alternatively, the decorative image 14 may be viewable while the dispenser 12 is both full and empty. Indication of volatile material 32 use-up may be achieved by more readily viewing image 14 as a result of the absence of colored volatile material within the dispenser 12. Dependent upon the specific volatile material composition, there may be numerous chemicals that either do not diffuse through the permeable membrane 24 or diffuse slower than the designed active ingredients or fragrances. Active ingredients may include chemicals such as esters, aldehydes, ketones, terpenes, alcohols, and aromatic compounds. As a result, material may be left within the blister 18 as it is nearly at or reaches a level of expiration in which replacement is necessary.

FIGS. 12-15 illustrate two material dispensing systems 10 that are alike in all respects but one to the system of the foregoing FIGURES. The only difference between the systems of FIGS. 12-15 and the foregoing FIGURES are certain added elements to the system 10 in each embodiment.

An illuminating device and base member have been added to the system 10 in one embodiment; a second embodiment further includes a reflective device. These added elements enhance the ambiance and visual effects of the system 10. The frame 16 is firmly fixed in an upright or substantially vertical position and the system 10 is configured to be placed upon a table top or other like surface. Additionally, the base member adds a stable surface for placing an illuminating device such as a candle or light bulb. The reflective device increases refractive light through the frame 16 and concentration of the light emanating from the illuminating device to further enhance the ambiance of the surroundings.

Additionally the reflective device increases the convective air flow close to the membrane 10 surface. This increases the release and diffusion of the volatile material 32 into the ambient atmosphere. The reflective device additionally reflects heat back in the direction towards the membrane 24. This volatizes the volatile material 32 more effectively due to the heat build-up.

While it is preferred that the illuminating device, base member, and reflective device are releasably attached to the frame 16 as shown in FIGS. 12-15, they may also be formed integral with the frame 16.

A base member and an illuminating device have been added to the frame 16 to enhance the decorative nature of the system 10 and provide a means for illuminating the frame whereby ambiance and aesthetic appeal to the user is provided. Without the base and illuminating device the system would not be as pleasant. As a result of the refractive and reflective materials the light rays emanating from the illuminating device add to the mood and ambiance of the ambient atmosphere.

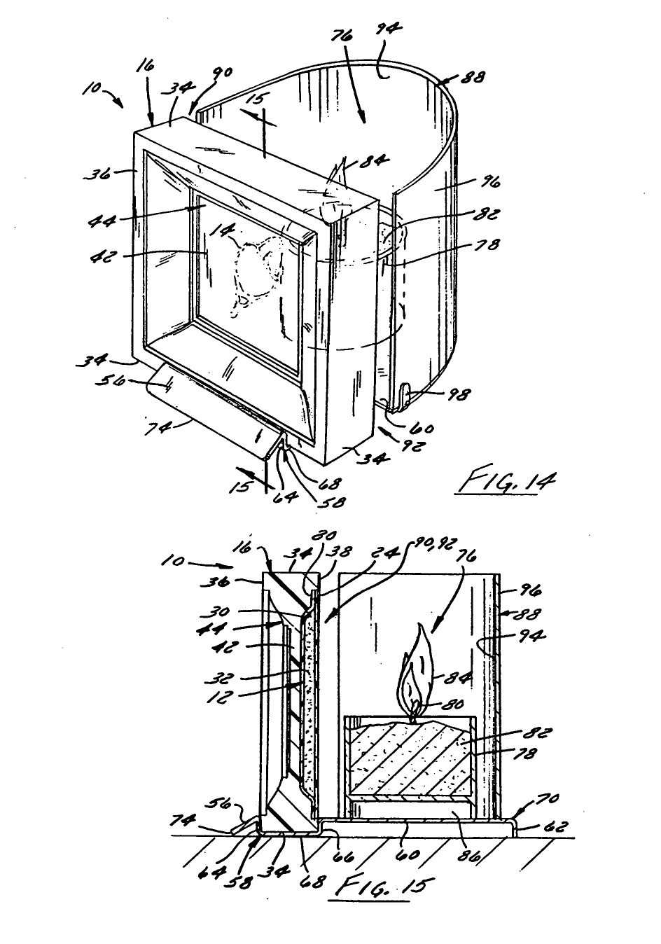

Referring to FIGS. 12 and 13, the system 10 includes a base member 54 that is positioned flat upon a support surface and is configured to hold frame 16. The base member 54 includes a support extension 56, a C-shaped clip 58, a base member extension 60 and a base extension support 62. The C-shaped clip 58 includes a pair of internal side walls 64, 66 and a bottom wall 68. Base member extension 60 includes an extension surface 70 and a protuberance 72.

C-shaped clip 58 attaches to and supports the frame 16 in an upright position and is a means for detaining frame 16. The side walls 64, 66 are in close communication with front face 36 and rear face 38 respectively. The bottom wall 68 is substantially flat and is in tight communication with a side wall 34 of the frame 16. The distance between the side walls 64, 66 is slightly wider than the width of the side walls 34. The orientation of the frame 16 and the extension surface may be altered to suit the user's personal preference. Alternatively, the C-shaped clip 58 is a spring clip, or other mechanical or adhesive retaining means that is configured to hold frame 16 in place.

Support extension 56 has a flat surface and an extension tip 74. The support extension 56 extends from side walls 64 to the tip 74. Tip 74 touches a supporting surface and thereby provides support and decorative design to the system 10. The extension 56 preferably has a length of between 5-10 mm and a width of between 30-50 mm.

Base member extension 60 is substantially rectangular, flat, and made of a thin piece of metal. Alternatively, the extension 60 may be made from injection molded plastic or molded glass. Extension 60 is preferably between 60 and 80 mm in length and approximately the same width as the frame 16. Extension 60 includes an extension surface 70 and a protuberance 72. The extension surface 70 is a substantially flat surface that is particularly suited for retaining an illuminating device 76. Surface 70 includes a protuberance 72 that extends perpendicularly from surface 70, and is positioned in the center of surface 70. Protuberance 72 is preferably between 10 and 20 mm in height. The base member support 62 is attached to and is positioned perpendicular to the extension surface 70. Support 62 props the surface 70 above a supporting surface or countertop. Support 62 is preferably between 20 and 30 mm in height.

Illuminating device 76 is preferably a candle that includes a cylindrical reservoir 78, wick 80, and fuel 82. Once lit, candle 76 maintains a flame 84 until the fuel 82 has been exhausted or the flame 84 has been otherwise extinguished. Reservoir 78 includes a center recess 86 at an opposite end from the wick 80. Reservoir 78 is preferably made of plastic or pressed metal and contains the fuel 82. Alternatively, reservoir 80 may be made of glass. Fuel 82 preferably is common candle wax that burns as the wick 80 is lit. Wick 80 is primarily surrounded by the fuel 82 and extends above the fuel 84. Candle 76 is preferably positioned proximal to the rear face 38. Placement of the illuminating device 76 behind the frame 16 permits the light to shine through and be refracted by the frame 16, thereby producing a pleasing ambiance in addition to volatile material diffusion.

When candle 76 is placed upon surface 70, the protuberance 72 extends into recess 86 and maintains the relative position of the candle 76 to frame 16. Illuminating device 76 is positioned upon extension surface 70 and proximal to the rear face 38. Reservoir 78 is preferably between 20 and 40 mm in height and has a diameter between 25 and 45 mm. Candle 76 is preferably viewed through wall 42.

Referring to FIGS. 14 and 15, the system 10 includes a reflective device 88 fixedly attached to the base member 54. Member 54 has an arciform shape that is similar to that of the reflective device and does not have a protuberance (FIGS. 12 and 13) but otherwise is the same as shown in FIGS. 12 and 13. Device 88 is attached to the member 54 by metal clips 98. Clips 98 are fixedly attached to the base member 56 and releasably attached to the exterior surface 96. Clips 98 may be welded, riveted, adhesively or attached in some other like manner.

The reflective device 88 is a thin planar wall that is easily flexed to form an arciform configuration. Device 88 in conjunction with frame 16 nearly surround candle 76 on all sides with the exception of two air vents 90, 92. Device 88 has an interior surface 94 and an exterior surface 96. Interior surface 94 has a mirrored and highly reflective coating. Surface 94 reflects heat and light from the candle 76. Alternatively, the reflective device 88 may be rigidly configured into an arciform shape.

A convective flow is created subsequent to the lighting of candle 76. Air flows into the air vents 92, 94 proximal to extension 56. After entering through the air vents 92, 94 air flows past the membrane 24 and upward out of the system 10. This convection better diffuses the volatile material 32 into the ambient atmosphere.

The reflective device has a mirrored face fronting the candle 56.

The illuminating device 76 may be formed integral to the dispenser 12 or as a separate apparatus attached to the device. Illumination can be achieved through a variety of devices. These include but are not limited to lighting devices that are LED's, incandescent, fluorescent, neon, HID, and chemo-luminescent.

It is understood that the present invention is not limited to the embodiments described above and illustrated herein, but encompasses any and all variations falling within the scope of the appended claims.

### INDUSTRIAL APPLICABILITY

The invention provides an improved volatile material dispenser with an illuminating device that enhances the ambiance of the ambient atmosphere.

1. A volatile material dispensing system, comprising:
a volatile material dispenser configured to dispense volatiles into an ambient atmosphere;
a volatile material contained within said dispenser, wherein said volatile material is selected from a group consisting of air fresheners, perfumes and insecticides;
a base member comprising a dispenser retaining means and an extension surface attached to said retaining means, wherein said base member is configured to releasably attach to said dispenser; and
an illuminating device configured to illuminate said dispenser, wherein said extension surface is configured to support said illuminating device.

2. The system according to claim 1 wherein said system further comprises a planar frame having a front face and a rear face, wherein said dispenser is affixed to one face of said frame.

3. The system of claim 1 wherein said dispenser further comprises a reservoir having a first surface and a nonporous polymer membrane, wherein said frame is rectangular and transparent, further wherein said illuminating device is a candle.

4. The system of claim 1 wherein said base member includes a protuberance extending from said extension surface that is configured to receive said illuminating device.

5. The system of claim 1, wherein said volatile material is a diffusible insecticide.

6. The system of claim 1 wherein said volatile material is a diffusible air fresheners.

7. The system of claim 3 wherein said membrane is collapsible upon said first surface.

8. The system according to claim 7 wherein said frame is rectangular and translucent.

9. The system according to claim 7 wherein said illuminating device is selected from the group consisting of a votive candle, free candle, LED, incandescent lights, fluorescent lights, neon lights, HID, chemo-luminescent lights, electro-luminescent lights, and OLED.

10. The system according to claim 7 wherein said illuminating device is a candle, wherein said candle is scented.

11. The system according to claim 8 wherein said frame further comprises a transparent wall.

12. The system of claim 11 wherein said frame further comprises a decorative image.

13. A volatile material dispensing system, comprising:
means for dispensing a volatile material into an ambient atmosphere;
a planar frame having a front face and a rear face, wherein said dispensing means is affixed to said frame;
an illuminating device configured to illuminate said frame and positioned upon an extension surface; and
a reflective device configured to reflect light emanating from said illuminating device, wherein said illuminating device is positioned between said frame and said reflective device.

14. The system of claim 13 wherein said dispensing means comprises a reservoir having a first surface and a nonporous polymer membrane, wherein said frame is rectangular and transparent, further wherein said illuminating device is a candle, further wherein said reflective device is configured to reflect heat.

15. The system according to claim 13 further comprising a base member wherein said illuminating device is positioned upon said base member, said base member is configured to fixedly maintain a substantially vertical position of said frame, further wherein said reflective device is releasably attached to said base member.

16. The system according to claim 13 wherein said reflective device has a mirrored interior surface and an arciform configuration, further wherein air vents are positioned between said reflective device and said frame.

17. The system according to claim 13 wherein said illuminating device is selected from the group consisting of a candle, LED's, incandescent lights, fluorescent lights, neon lights, HID, chemo-luminescent lights, electroluminescent lights, and OLED.

18. The system according to claim 13 wherein said frame is rectangular, translucent and further comprises a transparent window.

19. The system of claim 18 wherein said volatile material is a diffusible air freshener.

20. The system of claim 18 wherein said volatile material is a diffusible insecticide.

21. An illuminated volatile material dispenser, comprising:
a dispensing apparatus configured to support a reservoir containing a volatile material said reservoir enclosed by a vapor permeable membrane having a surface coplanar with a face of said dispensing apparatus;
an illuminating device configured to illuminate said frame and positioned upon a extension surface; and
a reflective device configured to reflect light emanating from said illuminating device, wherein said illuminating device is positioned substantially between said frame and said reflective device, wherein said illuminating device is proximal to said face.

22. The dispenser according to claim 21 wherein said dispensing apparatus includes a rectangular, planar, and translucent frame.

23. The dispenser according to claim 21 wherein said illuminating device is selected from the group consisting of a votive candle, free candle, LED's, incandescent light, fluorescent light, neon light, HID's, chemo-luminescent light, electro-luminescent light, and OLED's.
